(19) United States
(12) Patent Application Publication
(10) Pub. No.: US 2025/0244258 A1
(43) Pub. Date: Jul. 31, 2025

(54) METHOD AND DEVICE FOR INSPECTING THREE-DIMENSIONAL OBJECTS

(71) Applicant: ISRA VISION GmbH, Darmstadt (DE)

(72) Inventors: Jens HÜLSMANN, Hagen (DE); Daniel HEGELS, Dortmund (DE); Mohamad AJAMI, Berlin (DE); Ali AL RAZIQI, Griesheim (DE)

(21) Appl. No.: 19/181,927

(22) Filed: Apr. 17, 2025

(30) Foreign Application Priority Data
Apr. 19, 2019 (DE) 10 2024 110 992.0
Apr. 19, 2024 (DE) 10 2024 110 990.4

(51) Int. Cl. G01N 21/95; G01N 21/88

(52) U.S. Cl. CPC G01N 21/95; G01N 21/8806; G01N 2021/8854; G01N 2021/8887

(57) ABSTRACT

A method and device for inspecting three-dimensional objects, wherein each object includes a top side composed of at least one upper surface section and a plurality of lateral surface sections which extend obliquely, parallel or perpendicular to the at least one upper surface section or represent corner sections, and a bottom side. For each object, image data captured matrix-wise by a matrix camera is generated from an area lighting unit's light reflected from the top side in a rest state of the object and transmitted to a data processing unit, wherein the image data captured matrix-wise comprises light reflected from the lateral surface portions. The image data captured matrix-wise is further processed as a first overall matrix by the data processing unit, which performs segmentation of the first overall matrix and identifying a defect type of a detected defect and/or a severity of a detected defect and/or determining a quality score.

### CROSS-REFERENCE TO RELATED APPLICATIONS

This application claims priority to German Patent Application No. DE 10 2024 110 990.4 filed Apr. 19, 2024 and to German Patent Application No. DE 10 2024 110 992.0 filed Apr. 19, 2024, both of which are incorporated herein in their entirety.

### TECHNICAL FIELD

The invention relates to a method for inspecting three-dimensional objects, in particular so-called pouch battery cells (hereinafter referred to as pouch cells), and a corresponding device.

### BACKGROUND

Pouch cells are a type of battery that is used in particular for lithium-ion batteries. A pouch cell usually consists of a pouch-like housing or packaging formed by a plastic-coated metal foil (e.g. aluminium foil). This type of cell is therefore also referred to as a polymer battery. The housing is designed as a flexible, flat and lightweight pouch or cushion sealed to the outside. Inside the housing, there is usually a stack of superimposed electrode layers, active layers and separator layers. The terminals are formed as two tabs that protrude from the pouch-like housing adjacently on one side, on adjacent sides or on opposite sides. Pouch cells are known for their high energy density, compact design and flexibility, making them suitable for various applications, including electric vehicles. Pouch cells can be easily resized to meet the specific requirements of different electric vehicle models. Their flat and flexible design also allows for easier integration into different vehicle spaces, resulting in more efficient packaging and improved use of space. A disadvantage of the pouch cell design is that, due to their construction, they are generally sensitive to mechanical damage. This may easily cause the release of gases or electrolyte, or it may cause the cells to swell up considerably or cause internal short circuits.

It is therefore desirable to inspect such and other three-dimensional objects thoroughly during quality control to detect damaged objects at an early stage.

Various options for quality control of flat objects such as battery cells have already been disclosed. For example, a method is known from document US 2022/0 390 387 A1 in which optical coherence tomography (OCT) is used to inspect a gap between a lead foil and a tab of a pouch cell. This may provide information about the quality of the pouch cell seal, but this has very limited significance for the quality of the pouch cell. Document EP 4 117 081 A1 describes a very complex inspection system comprising a thickness measuring unit, a unit for measuring electrical properties, a printing unit, a tab cutting unit, a weighing unit, a tab testing unit and a defect selection unit. The thickness measuring unit measures the thickness of the pouch cell and the printing unit is used to print information about the pouch cell on its surface. The tab inspection unit determines the length and shape of the tab using vision inspection. Defective pouch cells are separated out into hoppers provided for this purpose by means of the defect selection unit. Document DE 10 2019 109 703 A1 shows and describes an arrangement for checking the quality of a battery cell whose transparent outer skin encloses an inner space. Inside the interior space, i.e. under the outer skin, an (additional) glass pin or a lithium metal wafer is arranged, which changes its optical appearance in the presence of a predetermined hydrogen fluoride concentration. Accordingly, this glass pin or lithium metal flake is analysed in a detailed manner by optoelectronic measurement to determine the hydrogen fluoride concentration and thus the quality of the battery cell. Finally, document EP 3 869 603 A1 describes a method for examining the quality of laminated electrode-separator composites and batteries with electrode-separator composites, which is suitable for large-scale production and ensures that the layers are securely and reliably connected to one another. The examination includes a detection of at least a proportion of the surface of the electrode separator composite by means of a detection device to generate a measurement result and the evaluation of the measurement result. The detection device is particularly suitable for determining the surface topography, surface temperature and/or surface colour. This may be done by means of an optical sensor, a photographic apparatus and/or a camera. In this case, the detection device may comprise at least one lighting device that can emit light onto the surface of the electrode-separator composite to be examined. The evaluation may comprise image processing and/or image analysis.

From the documents WANG, Xu; CHENG, Pan: ‘Deep learning-based visual defect inspection system for pouch battery packs’, Cognitive computing—ICCC 2022: 6th international conference; held as part of the services conference federation, SCF 2022; Honolulu, HI, USA, Dec. 10-14, 2022; proceedings; Cham, Switzerland; Springer, 2022 (Lecture notes in computer science), WO 2023/284 712 A1, EP 4 166 935 A1 and DE 10 2021 002 262 B3, further methods for the inspection of objects or for defect detection or tab detection are known.

The known methods mentioned above are either comparatively complex or only allow a very limited statement to be made about the quality of a three-dimensional object, for example of a pouch cell. Therefore, the object of the present invention is to provide a fast and sound method for inspecting an object that allows a comprehensive assessment of the quality of that object. Similarly, the object of the invention is to provide a corresponding inspection device.

### SUMMARY

The above object is solved by a method of inspecting three-dimensional objects, such as pouch cells, wherein each object comprises a substantially pouch-shaped or cuboid-shaped housing having a top side and a bottom side,
wherein the top side of the housing is composed of at least one upper surface section and a plurality of lateral surface sections which run parallel (optionally not on the same height as the upper surface section), obliquely or perpendicular to the at least one upper surface section or form corner sections,
wherein the bottom side of the housing is composed of at least one lower surface section and a plurality of lateral surface sections which run parallel (optionally not on the same height as the lower surface section), obliquely or perpendicular to the at least one lower surface section or form corner sections,
wherein image data captured matrix-wise by means of a matrix camera is generated for each object from an area lighting unit's light reflected from the top side in a rest state of the object to be inspected and transmitted to a data processing unit (optionally including reflected light at the upper tab surface of the first tab and/or the second tab), wherein the image data captured matrix-wise comprises light reflected from the lateral surface sections, wherein the image data captured matrix-wise is further processed as a first overall matrix by means of the data processing unit,
wherein the following steps are further performed by means of the data processing unit:
   segmenting the first overall matrix
      into a first image data portion comprising the image data of the upper surface section and
      into at least one second image data portion, wherein each second image data portion comprises the image data of at least one predetermined portion of the lateral surface sections and/or at least one predetermined corner section,
   subdividing the first image data portion into a plurality of individual patches,
   identifying a defect type of a detected defect and/or a severity of a detected defect and/or determining a quality score allowing an assessment of the quality of the object, based on
      a specific determination for each patch of the plurality of patches whether the respective patch of the first image data portion comprises one or more anomalies, by means of a correspondingly trained first neural network (NN) algorithm, wherein a defect is identified if an anomaly is present, and
      an identification of whether a defect is present in the at least one second image data portion, and a corresponding classification of the respective second image data portion by means of a correspondingly trained second NN algorithm which is different from the first NN algorithm.

The data processing unit may output the result of the identification or determination at a predetermined interface in order to make it accessible to a user. A display device may be connected to this interface to display the output result. In addition, the bottom side of the object may be inspected analogue to the above and the method steps explained below, i.e. a defect type of a detected defect and/or a severity of a detected defect and/or a quality score of the object may be determined/identified. The bottom side of the housing is composed of at least one lower surface section and a plurality of lateral surface sections which run obliquely, parallel or perpendicular to the at least one lower surface section or represent corner sections.

The method is used to inspect three-dimensional objects, for example flat objects in the form of a pouch or cuboid, for example for battery cells, e.g. pouch cells. In one embodiment, the present invention may be used for a flat object, wherein a three-dimensional object is referred to as a flat object if it exhibits significantly less spatial dimension in one spatial direction (e.g. height) than in the other two spatial directions and therefore essentially has the shape of a flat cuboid or a pouch shape or a shape similar to these shapes. Alternatively, the dimension in one spatial direction may also be larger, so that the object is described as essentially cuboid. In this context, ‘essentially’ means that the shape of the object approximates that of a pouch or a cuboid. For example, the cuboid may have steeply sloping edges. In many cases, such an object also comprises a first connection tab (short: tab, e.g. the anode) and, if applicable, at least a second connection tab (short: tab, e.g. the cathode), each of which projects laterally. Each object comprises a housing having a top side and a bottom side opposite the top side, wherein any tabs that project belong to the housing. The method according to embodiments of the invention may be used both for inspecting three-dimensional objects comprising one or more such tabs and for inspecting three-dimensional objects without such tabs. In particular, the method is suitable for objects that comprise stepped or terraced sections, particularly on their edge, or the aforementioned connecting tabs. The object is therefore viewed in such a way that one of the two largest sides forms a section at the top side and the opposite side, which is also large, forms a section of the bottom side. When the top side is on top and the bottom side is on the bottom, the top side of the housing has at least one upper surface section that runs essentially horizontally and is the surface section of the top side with the largest dimension. Further horizontally running surface sections, which run parallel to the upper surface section of the top side, may be provided, for example a terrace surface section of the top side. The top side further comprises a plurality of lateral surface sections that run obliquely, in parallel or perpendicularly to the at least one upper surface section (e.g. edges or lateral surfaces) or form corner sections. The lateral surface sections also comprise the sections running parallel to the upper surface section or a surface of a protruding tab (tab surface). Accordingly, the bottom side of the housing comprises at least one substantially horizontally running bottom surface section, which is the surface section with the largest dimension. Further horizontally running surface sections, which run parallel to the “upper” surface section of the bottom side, may be provided, for example a terrace surface section of the bottom side. The bottom side further comprises a plurality of lateral surface sections that run obliquely, in parallel or perpendicularly to the at least one lower surface section (e.g. edges or lateral surfaces) or constitute corner sections. The first tab and the at least one second tab, if present, may, for example, project from a short side and/or a long side and each comprise an upper tab surface and a lower tab surface. For example, the first tab and the second tab project from a single short or long side. In this case, they are arranged adjacently. Alternatively, the first tab and the second tab may project from opposite short or long sides. The housing may have a substantially rectangular shape (without taking into account any tabs that may exist) when viewed from above on the top or bottom side of the housing. The short side is the short side of this rectangle and the long side represents the long side of this rectangle.

To obtain the image data from the three-dimensional objects to be inspected, the three-dimensional objects are moved in a device used to perform the method, wherein a temporary rest state in which the three-dimensional object is not moved in the device is part of this movement. The movement of the three-dimensional objects is carried out by means of a drive unit that causes the relative movement of the objects to be inspected to the line lighting unit at a predetermined speed (motion state), for example essentially parallel to the upper surface section, for example in the direction of the largest dimension of the upper surface section (length) or transversely thereto. The predetermined speed is, for example, at least 500 mm/s, e.g. at least 800 mm/s. Furthermore, the drive unit is configured to cause the object to be arranged at a predetermined position and for a predetermined time period in relation to an area lighting unit during the further movement of the respective object at rest (rest state). In this case, the predetermined time period for the arrangement of the object in the rest state may be before the motion state or after the motion state. The predetermined time period in the rest state may, for example, be at least 300 ms, e.g. at least 400 ms. In one embodiment, the drive unit is realised by a slide that can be moved in a predetermined manner on a linear unit. The slide comprises, for example, suction cups by means of which the housing of the object can be attached to the slide on its bottom side. The motion data for moving the three-dimensional object to be inspected (i.e. its arrangement in the motion state and in the rest state, the position of the object and/or its velocity etc.) is captured by a motion detection unit and transmitted to the data processing unit. There, the captured motion data (motion information) is used together with the captured image data from the matrix camera to determine/identify the presence of defects and/or to determine the quality score.

The area lighting unit illuminates the top side (for example the entire top side) of the housing, optionally including the upper tab surface of the first tab and/or the second tab of the object to be inspected, from above. In one embodiment, the entire top side of the housing (optionally including the upper tab surface of the first tab and/or the second tab) or at least a greater section of the top side of the housing (optionally including the upper tab surface of the first tab and/or the second tab), for example at least 70%, e.g. at least 80%, of the entire top side of the housing is illuminated by the area lighting unit. For example, the light from the area lighting unit is incident on the top side of the housing (optionally including the top tab surface of the first tab and/or the second tab) perpendicular or obliquely, e.g. at an angle of incidence in the range of 10° to 60° with respect to the horizontal direction. By means of the oblique illumination by the area lighting unit, defects such as indentations, protrusions, scratches, folding defects, edge cracks, defects at the sealing and similar topological defects may be easily detected. Defects in the form of absorbing defects (e.g. contamination, foreign bodies on the surface) may also be detected. The area lighting unit is realised by LED spots or other quasi-spotlights. In one embodiment, at least one second deflecting mirror is arranged above the position of the object to be inspected in the rest state, which extends perpendicular to the horizontal direction and deflects the light from the area lighting unit so that it falls obliquely from above onto the top side of the pouch-shaped housing (optionally with tabs). This may reduce the overall external dimensions of the inspection device.

A matrix camera captures the reflected light of the top side of the housing illuminated obliquely from above, optionally including the upper tab surface of an object to be inspected arranged in the rest state, matrix-wise in the form of image data (intensity and, in one embodiment, an additional colour value) and transmits this captured image data to the data processing unit. In one embodiment, the matrix camera may capture the entire top side of the housing. For example, the matrix camera is arranged above the object when the object is in its rest state at the predetermined position, i.e., in this embodiment, the matrix camera is located above the rest state position of the object to be inspected.

The matrix camera may, for example, be designed as a CCD or CMOS camera. The matrix camera captures the light intensity of a large number of pixels in the field of view, which are arranged in rows and columns, i.e. in a matrix. For this purpose, the matrix camera comprises a light-sensitive element (e.g. a CCD or CMOS sensor) for each pixel. The size of the area captured by each light-sensitive element determines the resolution of the matrix camera. The matrix camera may, for example, comprise a field of view of 9344×7000 pixels or 8192×8192 pixels and thus captures image data with a size of 805×603 mm. The line-by-line capture may accordingly comprise an area of 16 to 128×1000 to 8192 pixels, for example. The matrix camera is also arranged in such a way that it looks vertically from above at the object to be inspected in the rest state, so that it sees this section of the field of view in focus. The matrix camera is focused in such a way that it comprises a sharpness that is as uniform as possible over the entire field of view. In particular, this is realised for a line of sight in which the image data from the object reaches the matrix camera via mirrors (e.g. from the lateral surface sections). This is achieved by a corresponding aperture setting, which realises the necessary depth of field.

The inspection method according to embodiments of the invention is characterised by the fact that, by means of the segmentation of the image data which is captured matrix-wise (‘first overall matrix of image data’), different elements of the image data which have different analysis requirements for the inspection are separated and analysed by means of different methods. In an advantageous manner, the image data of the comparatively flat area of the upper surface section (‘first image data portion’), which is prominent in terms of its expansion, is initially processed and analysed separately from the image data of a lateral surface section, including the corner sections (‘second image data portion’), which is of smaller dimension and is expected to have greater bumpiness. In the case of the first image data portion, it has proved advantageous in terms of computing speed to subdivide this portion into a large number of patches and then use the first NN algorithm, as described in more detail below, to determine whether one or more anomalies are present in the respective patch. If at least one anomaly is present, a defect is detected/identified. In the second image data portion, whether a defect is present may be determined based on a second NN algorithm, which is described in more detail below. In addition, a classification of this defect may be performed.

For the overall quality assessment, the individual analyses are combined and considered together. In particular, the defect type of a detected defect is identified and/or its severity and/or a quality score is determined for the object, which allows the quality of the object to be assessed. For example, the identified defect types and/or their severity are also used for this purpose. As described above, it is advantageous that the respective image data portions obtained by means of segmentation are analysed using different algorithms that are adapted to possible defect types. This may also create a time advantage and an accuracy advantage for the evaluation of the image data. In other words, by analysing the different sections separately, meaningful results can be achieved quickly during the inspection, as image data processing is adapted to the specific characteristics of the object.

The segmentation is carried out in particular by means of so-called layout recipes. Each layout recipe predefines a given section of the object with regard to the field of view of the matrix camera/camera. As the object is not always exactly in the pre-defined ideal position when the image is captured by the matrix camera, but may be shifted/rotated by a few pixels, a position correction is carried out, for example, using specified fixed points of the object, i.e. a registration to the expected position is carried out, so that the first overall matrix (or correspondingly the n first overall matrices or the second overall matrix determined from the lineby-line observation) is adapted accordingly to the ideal position of the object. The aforementioned matrices with image data are rotated and/or shifted accordingly. Once this adaptation has been carried out, the desired image data portions may be reliably identified using the specified layout recipe and extracted accordingly.

From the image data (image information) transmitted by the matrix camera to the data processing unit, for example, defect types such as inclusions, craters (dents), protrusions (bumps), contamination (dust, electrolyte residues), pseudo-edges, orange skin, pores, cracks, grinding grooves, specks, surface defects, blistering, scratches, wet prints are determined by processing the data in the data processing unit as described in more detail below.

In one embodiment of the method, the classification of the at least one second image data portion is carried out by means of a classifier with two states or a classifier with at least 3 states, wherein the classifier with at least 3 states allows, for example, the assignment of different types of defects, whereas, by means of a classifier with two states it may be assessed whether a defect is present or not.

In one embodiment of the method, for each object by means of a camera, for example by means of the matrix camera, a plurality of line-by-line captured image data of reflected light of a line lighting unit at line-shaped areas of the top side (optionally including the upper tab-surface of the first tab and/or the second tab) in a motion state of the object to be inspected are generated and transmitted to a data processing unit, wherein the following steps are further performed by means of the data processing unit:
merging the image data captured line-by-line into a second overall matrix comprising the image data of the top side of the object,
identifying a defect type of a detected defect and/or a severity of a detected defect and/or determining a quality score which allows an assessment of the quality of the object, additionally based on the image data of the second overall matrix.

The identification of the defect type of a detected defect and/or a severity of a detected defect and/or the determination of a quality score, which allows an assessment of the quality of the object, based on the image data of the composite second overall matrix may, in an embodiment, also be performed instead of the above-mentioned determination based on the separate determination for each patch of the plurality of patches, whether the respective patch of the first image data portion comprises one or more anomalies, by means of a correspondingly trained first NN algorithm, and in combination with the above-mentioned identification of whether a defect is present in the at least one second image data portion and a corresponding classification of the respective second image data portion by means of a correspondingly trained second NN algorithm. Alternatively, the identification of the defect type of a detected defect and/or a severity of a detected defect and/or the determination of a quality score, which allows an assessment of the quality of the object, based on the image data of the composite second overall matrix may in an embodiment also be performed instead of the above-mentioned identification of whether a defect is present in the at least one second image data portion, and a corresponding classification of the respective second image data portion by means of a correspondingly trained second NN algorithm, and in combination with the determination explained above, based on the separate determination for each patch of the plurality of patches, whether the respective patch of the first image data portion comprises one or more anomalies, by means of a correspondingly trained first NN algorithm.

When the image data of the object is captured line by line, the captured ‘image lines’ are combined/merged to form a matrix image (second overall matrix). The merging comprises the positional juxtaposition of the line-by-line captured image data of the object, so that a matrix of image data (second overall matrix) is created, wherein discrepancies/overlaps are corrected, if necessary. In other words, the second overall matrix contains the individually line-by-line determined image data for the entire upper side of the object or for a predetermined section of this upper side corresponding to the position at which the incident light of the line lighting unit was reflected on the top side of the object, and thus also contains an image of the top side of the object. In this connection, the image of the second total matrix may be rectified so that the resulting image is equivalent to the first total matrix or one of the n first total matrices, e.g. with regard to the size of the matrix and/or the position of the captured part of the upper side of the object. The second total matrix is used for the further analysis of the image data described below.

The line lighting unit illuminates a line-shaped area of the top side of the housing (optionally including the upper tab surface of the first tab and/or the second tab). For example, the line lighting unit is formed by a light with a plurality of LEDs arranged to illuminate a desired line-shaped area. In this case, one LED line or, for a wider line-shaped area, several LED lines lying adjacently (e.g. 2 to 10 LED lines) may be provided. In one embodiment, the line lighting unit may be switched in such a way that it illuminates each point of the line-shaped area with light of two different intensities (i.e. with high intensity A and with low intensity B). Accordingly, the line-by-line detection of the light reflected from the line-shaped area of the top side (optionally of the upper tab surface of the first tab and/or the second tab) is carried out with an adapted switching rhythm in the form ABABAB . . . (i.e. the two different intensities A, B are switched alternately). The line-by-line capture of the image data (capture frequency and time of capture) and the feed rate of the drive unit are synchronised for this purpose. This illumination is also referred to as High Dynamic Range (HDR) reflection bright field illumination and has advantages with regard to the identification of certain types of defects, for example the contamination of the object by a transparent substance, due to the special lighting technology. The line-by-line capture of the image data may be carried out by a camera with a appropriate field of view and resolution, for example by the matrix camera, which also performs the matrix-by-matrix capture of the image data. After capture by the matrix camera, the data (image data) is transmitted to the data processing unit and additionally used to inspect the three-dimensional object, wherein the line-by-line captured image data is combined/merged to form an overall image (second overall matrix) of the respective top side of the object prior to the analysis, as described above.

It shall be emphasized that, in one embodiment, by means of a single matrix camera, the reflected light of the line-shaped illuminated area of the top side of the housing of the object to be inspected in the motion state is recorded line-by-line in the form of image data (image information, e.g. intensity and in one embodiment additionally a color value) and the reflected light of the top side of the housing illuminated from above (optionally obliquely illuminated, including the top tab surface, if applicable) is recorded matrix-wise in the form of image data (image information, e.g. intensity and in one embodiment additionally a color value) of an object to be inspected arranged in the rest state and both captured image data is transmitted to the data processing unit. Line-by-line capture represents a subregion of the field of view of the matrix camera and results in one pixel line or several adjacently positioned pixel lines (e.g. pixel lines having 16 to 128 pixels) with image data, whereas matrix-by-matrix capture results in a pixel matrix with image data, wherein the pixel matrix also represents a subregion of the field of view. In one embodiment, the image data may be determined in a predetermined wavelength range. The field of view of the matrix camera is designed in such a way that matrix-wise image data and line-by-line image data are captured by a single fixed (i.e. during capture of image data immobile) matrix camera, which are subsequently assigned to the respective object by the data processing unit. In this context, the entire top side of the housing (optionally including the upper tab surfaces of the first tab and/or the second tab) or at least the section of the top side of the housing illuminated by the area lighting unit may be captured during matrix-wise capture, i.e. at least a greater section of the top side of the housing (optionally including the upper tab surface of the first tab and/or the second tab), for example at least 70%, e.g. at least 80%, of the entire top side of the housing of the object to be inspected. The advantage of using the matrix camera for the matrix-wise and line-by-line capture of image data is that the image data obtained does not have to be harmonised with regard to the capture instrument. They contain the same camera properties. The inclusion of the line-by-line image data in the inspection further improves the quality assessment.

In one embodiment of the method the following further steps are carried out by means of the data processing unit:
segmentation of the second overall matrix
   into a third image data portion comprising the image data of the upper surface section and/or
   into at least one fourth image data portion, wherein each fourth image data portion comprises the image data of at least one predetermined section of the lateral surface sections (wherein in this portion corner portions may be excluded) and/or at least one predetermined corner section,
subdividing the third image data portion into a plurality of individual patches,
wherein identifying a defect type of a detected defect and/or a severity of a detected defect and/or determining a quality score that allows an assessment of the quality of the object based on
   determining specifically for each patch of the plurality of patches whether the respective patch of the third image data portion comprises one or more anomalies by means of the first NN algorithm, wherein a defect is identified if an anomaly is present, and/or
   identifying whether a defect is present in the at least one fourth image data portion and classifying the respective fourth image data portion accordingly by means of the second NN algorithm.
      The image data merged line by line and previously captured line by line may be analysed in the third image data portion defined above analogously to the image data determined matrix-wise by means of the first NN algorithm after decomposition into a plurality of individual patches and/or in the fourth image data portion by means of the second NN algorithm with regard to the presence of a defect. This method is also applicable to the image data captured line by line and has the advantages stated above.

In one embodiment of the method, for each object at least n (n≥2) recordings (captures of the matrix camera) of the top side, e.g. the top side (optionally of the entire top side, optionally including the upper tab surface), of image data captured matrix-wise are generated by a temporally successive capture of reflected light and transmitted to the data processing unit, wherein the matrix-wise captured image data are further processed as n first overall matrices by means of the data processing unit, wherein the reflected light is generated by a temporally separated illumination of the entire top side of the housing of the object in the rest state of the object to be inspected obliquely from above from n different directions. The n recordings are transmitted to the data processing unit. Accordingly, in this embodiment, the area lighting unit is configured to illuminate the top side of the housing, e.g. the entire top side of the housing, of the object to be inspected in the rest state (optionally including the upper tab surface of the first tab and the second tab of the object to be inspected) temporally successively and obliquely from above from at least n different directions, and the matrix camera is configured accordingly for the temporally successive matrix capture of the image data of the light reflected from the upper side of the housing during illumination from the at least n directions of the area lighting unit. The data processing unit is correspondingly configured to receive and process the n image data captured matrix-wise during illumination from the n directions of the area lighting unit, wherein this image data is assigned to the respective object. The image data captured matrix-wise in the form of n recordings are further processed as n first overall matrices by means of the data processing unit.

In one embodiment of the inventive method the following steps are further performed by means of the data processing unit:
segmentation of the n first overall matrices
   into n fifth image data portions comprising the image data of the upper surface section of each of the n first overall matrices and/or
   into n sixth and optionally further image data portions of each of the n first overall matrices, wherein each sixth and optionally further image data portion comprises the image data of at least one predetermined portion of the lateral surface sections and/or at least one predetermined corner section,
determining in each case a maximum image and/or an absorption image and/or a topology image from the image data of the fifth image data portion and/or the sixth image data portion and/or the possibly further image data portions,
determining defects as well as analysing and characterising defects in the maximum image and/or in the absorption image and/or in the topology image of the fifth image data portion and/or of the sixth image data portion and/or of the further image data portions, if applicable,
wherein the identification of a defect type of a detected defect and/or a severity of a detected defect and/or the determination of a quality score, which allows an assessment of the quality of the object, is based on the result of the analysis and/or characterisation of the respective detected defects.

As explained in more detail below, the additional defect analysis and determination by means of methods in which no NN algorithms are used may further accelerate the inspection, as, for example, the threshold analysis of the pixels of the maximum image and/or the absorption image and/or the topology image as well as the creation of the maximum image and/or the absorption image and/or the topology image can be carried out very quickly. Both the matrix-wise generated image data and the line-by-line generated image data can be used for this purpose.

In this embodiment of the method with n recordings of the image data captured matrix-wise, in particular, the image data of the fifth image data portion, the sixth or further image data portions, the image data of a maximum image and/or a topology image and/or an absorption image are used as image data for further analysis. The matrix image, the topology image and/or the absorption image are each generated from the n matrix-wise captures of the respective image data portion captured temporally successively. The maximum image represents the image data of the areas that are best accessible in relation to the respective lighting situation and are therefore recognised as the brightest. The topology image has the advantage that it emphasises topology changes in the image, while the absorption image accentuates defects caused by the absorption of light (e.g. contamination on the surface).

For example, the image data of the n captures is generated pixel-identically, i.e. the image data of the at least two matrix-wise captures of the top side (optionally of the entire top side, optionally including the top tab surface of the first tab and/or the second tab) are each generated from the same points on the surfaces. Each of these matrix-wise captures is referred to as an image data matrix M, wherein at least two image data matrices Mk (k≥2, k=2 . . . n) are captured for each object. A pixel Pi of the captured first image data matrix M1 thus corresponds to the same location on the surface of the top side (optionally including the upper tab surface) as the same pixel Pi of the captured second (third, fourth, etc.) image data matrix Mk (M2, M3, M4, . . . . Mn). The captured light intensity in the pixel Pi is denoted as i(Pi). The captured light intensity of the first image data matrix M1 at pixel Pi is referred to as i₁(Pi). Each image data matrix comprises, for example, image data of the above-defined first image data portion.

The maximum image may be determined by forming the maximum of the light intensities of all image data matrices Mk in the respective pixel Pi, i.e. Max (i₁(Pi), i₂(Pi)) for two determined image data matrices M1, M2 for two illuminations from two different directions or Max (i₁(Pi), i₂(Pi), . . . iₙ(Pi)) if n illuminations from n different directions are used. In one embodiment, n=4. The maximum is calculated for each pixel Pi and—represented in the entire matrix (maximum matrix)—results in the maximum image.

The topology image and the absorption image may be determined by first separately applying two differently parameterised low-pass filters (e.g. box filters) to each image data matrix Mk of each lighting situation independently of each other and subtracting them from each other:

$$Fk = low - pass 1 ( Mk ) - low - pass 2 ( Mk )$$

Herein, the parameters of the two low-pass filters low-pass1 and low-pass2 differ, for example, in such a way that the first parameter of the first low-pass filter low-pass1 is smaller than the second parameter of the second low-pass filter low-pass2. The light intensity assigned to each pixel Pi of the matrix Fk by this operation is referred to as fk(Pi) (k=2 . . . n). Subsequently, from the resulting matrices Fk analogously to the maximum image above the minimum or maximum pixel by pixel over all matrices a minimum matrix MinM and a maximum matrix MaxM is determined, wherein each point Pi of the minimum matrix MinM is calculated as Min (f1(Pi), f2(Pi), . . . fn(Pi)) and each point Pi of the maximum matrix MaxM is calculated as Max (f1(Pi), f2(Pi), . . . fn(Pi)). Subsequently, a matrix H is determined with the values h (Pi), which is determined from the product—again determined pixel by pixel—of the minimum value and maximum value calculated at the respective point Pi with a scaling factor a (for example a=64). This means that for each point Pi, the value is

$$h ( Pi ) = Min ( f 1 ( Pi ) , f 2 ( Pi ) , … fn ( Pi ) ) * Max ( f 1 ( Pi ) , f 2 ( Pi ) , … fn ( Pi ) ) * a$$

Finally, a matrix Q with the values q(Pi) is determined from this, wherein

q(Pi)=sqrt(abs(h(Pi))),

wherein abs(q(Pi)) is the absolute value of the value q(Pi) and sqrt( ) is the root function. This results in the values of the topology matrix T with the values t(Pi) as follows:

$$t ( Pi ) = q ( Pi ) if h ( Pi ) \leq 0 or t ( Pi ) = 0 if h ( Pi ) > 0.$$

Accordingly, the values of the absorption matrix A with the values a (Pi) are obtained as follows

$$a ( Pi ) = q ( Pi ) if h ( Pi ) > 0 or a ( Pi ) = 0 if h ( Pi ) \leq 0.$$

The topology matrix T calculated in this way with the values t(Pi) is also referred to as the topology image and the absorption matrix A with the values a(Pi) is also referred to as the absorption image.

If the matrix-wise capture of the light reflected upwards from the top side (optionally from the entire top side and/or optionally including the upper tab surface) of the area lighting unit is carried out four times with illumination obliquely from above from four different directions, the directions are selected, for example, so that the illumination is carried out from both opposite long sides and from both opposite short sides of the housing. Alternatively, the lighting may illuminate the top side from the direction of each of the four corners of the housing. In one embodiment, it is advantageous if the captures are produced with illuminations, wherein all illumination directions optionally cover an angle of 360° in total with regard to their components running in the plane of the upper surface section (i.e. when illuminating from four different directions, the illumination is provided from directions offset by 90° in each case, or when illuminating from six different directions, the illumination is provided from directions offset by 60° in each case, etc.).

In this embodiment, the maximum image and/or absorption image and/or topology image and/or the third image data portion and/or at least one fourth image data portion generated for the fifth image data portion (e.g. one upper surface section) and/or the sixth image data portion (e.g. four lateral surface portions) and possibly further image data portions (e.g. four corner portions) is then further used for inspection. For example, by means of one or more threshold values specified for the respective image (maximum image, absorption image, topology image) and/or for the third image data portion and/or for the at least one fourth image data portion, locations are analyzed pixel by pixel in the respective image/portion at which the respective value of the respective pixel exceeds or falls below the respective threshold value. It is assumed that a defect is present if the respective threshold value is exceeded or not reached. Subsequently, further properties of these defects are determined, e.g. their expansion (in pixels), a histogram of grey values in the area of the defect. This may be used to identify the respective defect type and/or the severity of the defect. Analysis values and the assignment of the defect type may, for example, be carried out using corresponding tables stored in the data processing unit.

In one embodiment, four corner image data matrices are extracted by the data processing unit from the segmented image data or by the segmentation itself, which contain at least a second image data portion or a fourth image data portion or a sixth or further image data portion, wherein each matrix contains one corner of the housing and its position is precisely known, for example after the position correction described below. Alternatively, another image data portion of the object may be extracted. If necessary, a maximum matrix of several recordings is generated in advance.

The corner image information matrix of each corner (i.e. each corner section) may, for example, be analysed separately using a Convolutional Neural Network (CNN) algorithm as a second NN algorithm comprising a binary classifier (classifier with two states, namely ‘intact corner’ and ‘defective corner’). The corner image data matrix or alternatively the image data matrix of the other image data portion may be defined comparatively small (e.g. 128×128 pixels) and underlying image data stem from the area of the respective corner of the housing only. This CNN model was specially developed for this classification task with few classes and for matrices with few pixels. This CNN model comprises a compact structure that is, for example, more compact than conventional deep architectures. For example, it consists of three strands with different convolution sizes, which are merged later. This structure reduces the number of parameters to be trained so that the model has fewer features to learn. For this reason, it is ideally suitable for binary or other low-dimensional classification. For the training and evaluation of the CNN model, a large and broad dataset containing matrices of corner structures and corresponding expected defects is used. It is compiled in relation to the respective object to be analysed and annotated by engineers. This dataset contains images of corners of the respective objects (i.e. of the pouch-cells to be inspected), which are divided into two classes: “defective” and “intact”. The images were carefully selected and annotated to ensure that they cover a wide range of defects and variations in the corners. Training of the model is performed on the dataset, wherein the images in the dataset may be split into training sets and validation sets. For example, a ratio of 80% may be used for the training data and 20% for the validation data. In addition, a five-fold cross-validation may be performed to ensure that all images are present in the training data and in the validation data. The model consists of several convolutional layers, pooling layers and fully connected layers, which enable the model to extract important features in the images and recognise the subtle differences between defective and intact corners. The convolutional layers are used to train the trainable weights of the convolution operations, which are then used to recognise image features. These features are then aggregated with the pooling layers. Subsequently, the weights of the fully connected layers are iteratively trained to determine a probability for the associated class from the features. In addition, prior to the analysis with the CNN algorithm, all images/segments may be cut out in the same size as the corner image data matrices to be analysed (128×128 pixels) and oriented in such a way that they were caused to have the same orientation to enable a consistent view.

In a further embodiment, at least one predetermined portion of the lateral surface sections (e.g. terrace sections of a pouch cell) is extracted by the data processing unit from the segmented image data, which includes at least one second image data portion and/or at least one fourth image data portion and/or a sixth or further image data portion, or by the segmentation itself. Each predetermined portion is analysed using an object detection network based on the Mask-RCNN model as another second NN algorithm. The algorithm recognises defects of a variety of different defect types (e.g. 6 different defect types such as protrusion/nose/prominence, indentation, fold, scratch, contamination, particle) and adds a corresponding bounding box to the data of the corresponding second image data portion in the area of the defect. To train the Mask-RCNN model as an algorithm, data representing a corresponding second image data portion is used, wherein the corresponding defects are annotated in these image data matrices and provided with a bounding box. The architecture of the Mask RCNN model was carefully selected. This model is a further development of the Faster R-CNN model and is able to generate bounding boxes and masks for defects in the specified areas. Rarely occurring defect types are artificially inserted into corresponding image data portions of the given areas to train the model. The performance of each model is evaluated using a separate validation dataset. For example, a validation data set with a ratio of 80% for the training data and 20% for the validation data may be used. This ensures that the model recognises defects efficiently and accurately and classifies them correctly.

In a further embodiment, at least one predetermined portion of the upper surface section is extracted by the data processing unit from the segmented image data comprising at least a first image data portion, or by the segmentation itself, which in one embodiment comprises the entire upper surface section. Additionally, the resolution in the predetermined (sub-) region may be reduced to a predetermined value (e.g. from 5120×2216 to 841×265 pixels) to speed up the process. The image is divided into several small patches (subregions). Subsequently, a pretrained CNN algorithm ‘Wide ResNet-50’ is used as the first NN algorithm to examine each patch to determine whether one or more predetermined features (defects/anomalies) are present in the respective patch. In ‘Wide ResNet-50’, the layers of the network are made ‘wider’ by increasing the number of channels in the convolutional layers. This CNN is able to recognise complex patterns and textures. It has also been observed that such wider CNNs are often better able to generalise, meaning that they may process new, unknown data more effectively. The method is also known as PaDiM (Patch Distribution Modelling Framework for Anomaly Detection and Localisation) and is an algorithm for the task of anomaly detection and localisation. This approach is particularly suitable for the detection of industrial defects, where the aim is to identify irregularities or deviations from the norm in visual data. PaDiM models the distribution of features in an image. Subsequently, the features extracted by the CNN are collected for each patch. For each patch, the Mahalanobis distance between the features of the patch and a normal distribution derived from the training data is calculated. This step determines how ‘abnormal’ or unusual each patch is compared to normal training data. The calculated Mahalanobis distance serves as the anomaly score, wherein a higher value indicates a greater deviation from normality. A threshold is set based on the anomaly score. Patches with a score that exceeds this threshold are considered abnormal. Anomalies are localised by marking the positions of the patches classified as abnormal in the image data portion, which enables the localisation of the anomalies in the respective image data portion.

The anomaly score is calculated separately for each patch by calculating the Mahalanobis distance of its features from the expected normal distribution, which is represented by the mean value and covariance matrix from the training data. A large Mahalanobis distance indicates that the features of the patch deviate strongly from the normal distribution, indicating a potential anomaly. Mathematically, the Mahalanobis distance D of a point x to a distribution with the mean value u and the covariance matrix 2 is calculated as follows:

$$D ( x ) = \sqrt{{( x - μ )}^{⊤} {Σ}^{- 1} ( x - μ )}$$

D(x) refers to the Mahalanobis distance for the point.
x refers to the vector of observed values.
μ is the mean value vector based on the training data volume.
Σ refers to the covariance matrix of the training data.
Σ⁻¹ is the inverse of the covariance matrix.
T denotes the transposition of the vector.

For each patch, the anomaly score results in an assessment of the severity of the defect present in the respective patch.

The application of the second NN algorithm (CNN algorithm, mask RCNN algorithm) to the corresponding image data portions also results in detected defects, a defect type and, for the detected defects (wherein defective corners are included), a severity of the respective defect (or defective corner). In addition, as explained above, defects in the respective image/portion are also detected, analysed and characterised by means of defect detection using a maximum image and/or an absorption image and/or a topology image and/or an image data portion based on values determined line by line. A defect type is also assigned and the severity of the respective defect is determined. The respective severity level may, for example, be assessed on the basis of the size of the respective defect, wherein a small defect is assigned a severity level of a small class of severity levels (e.g. class 1) and a more extensive defect is assigned a severity level of a larger class (e.g. class 4). Alternatively or additionally, other parameters of the defect may be used to assess the severity, e.g. the position of the defect on the object.

The size of the defect may, for example, be determined by the data processing unit after taking into account the perspective and/or optical distortion of the matrix camera. Analogously, a dimension of the object may be determined (e.g. the edge length of the housing).

Once the above information on the detected defects and their severity has been determined, the data processing unit carries out an overall evaluation for each object, for example using a quality score. All identified defects and their severity are included, wherein different defects may be weighted differently depending on their severity. From this, it is determined, for example by using a corresponding table provided in the data processing unit, whether the object meets the specified quality requirements or not, i.e. the determined quality score is less than or greater than or equal to a quality score threshold value. In both cases, the determined data (defect, severity of the defect, size of the defect, position/location of the defect) may be output at an interface of the data processing unit for further processing of the object and made available for further processing.

For capturing of the image data, in one embodiment, the matrix camera is configured such (e.g. is controlled by the data processing unit in such a way) that the line-by-line and the matrix-wise capture of the image data takes place in a recording sequence (temporal sequence of a sequence of recordings of the matrix camera over its entire field of view). This may be synchronised with a corresponding control of the lighting (i.e. the line lighting unit and/or the area lighting unit). In one embodiment, the image data to be captured line-by-line of a first object to be inspected (in motion state) may be captured at least partially simultaneously with the image data to be captured matrix-wise of a second object to be inspected that is different from the first object (in rest state). Such a design of the recording sequence may shorten the overall time required for the quality assessment of the object. This means that the matrix camera is configured such that at least one of its captures (i.e. in the same capture) of a recording sequence (i.e. in the same capture) contains.
line-by-line the line lighting unit's light reflected from the line-shaped area of the top side in the motion state of a first object into the matrix camera and
matrix-wise the area lighting unit's light reflected upwards from the top side (in one embodiment of the entire top side and/or optionally including the upper tab surface of the first tab and/or the second tab) in the rest state of a second object, optionally including the light reflected from the lateral surface sections of the second object, if applicable via the first deflection mirrors, into the matrix camera, wherein the second object is different from the first object.
   Capture and illumination sequences may, for example, include a plurality of line-by-line captures (for example, between 50 and 120 line-by-line captures) of the light reflected from the line-shaped area of the top side (optionally including the upper tab surface of the first tab and/or the second tab) and, where partly in the same capture, one of some (between 5 and 20) matrix-by-matrix captures of the top side. Alternatively, the image data to be captured lineby-line and the image data to be captured matrix-wise of two different objects may be recorded sequentially by the matrix camera in the capture sequence. In this case, to save time, only sections of the entire pixel matrix of the matrix camera may be read out, e.g. the corresponding section of the line-by-line capture and the corresponding section of the matrix-wise capture.

When capturing the image data, the matrix camera is at rest (i.e. it does not move, nor do parts of it move) and the dimensions of the field of view of the matrix camera are such that both the image data to be captured line-by-line and the image data to be captured matrix-wise are contained in the same field of view. The object to be inspected is in a motion state during line-by-line capture, i.e. the object to be inspected continues to move while the image data is being created. In contrast, the object to be inspected is at rest at a predetermined position and for a predetermined time period (i.e. at rest state) during matrix-wise capture, so that the image data captured matrix-wise can be determined accurately. Furthermore, at least two first deflection mirrors may be provided next to the object to be inspected, which may also be captured by the field of view of the matrix camera and which provide further image data of the lateral surface sections of the top side of the object to be inspected. In this embodiment, these are captured together (simultaneously, i.e. in the same recording) with the matrix-wise capture of the object to be inspected. The image data captured line-by-line and the image data captured matrix-wise, including, if applicable, the image data transmitted via the first deflection mirrors, are assigned to the respective inspected object and included in the determination of the presence of a defect of at least one defect type and or a quality score.

In the above embodiment, the arrangement and inclination of the first deflection mirrors is such that the matrix camera receives the light reflected from the largest possible area of the respective lateral surface sections of the top side. In one embodiment of the device, at least two, in particular four, first deflection mirrors are provided, wherein in the rest state of the object each first deflection mirror is arranged next to a respective side of the housing. With four first deflection mirrors, the reflected light of the lateral surface sections of all sides of the housing may be captured. As an example, each first deflection mirror is designed in such a way that its length (largest dimension, dimension parallel to the respective side next to which the first deflection mirror is arranged) corresponds at least to the length of the respective side of the housing. Further, in one embodiment, each first deflecting mirror is arranged in a horizontal direction at a distance of at least 30 mm from the respective side of the housing. In a further embodiment, the width of each first deflecting mirror (dimension perpendicular to the respective side next to which the respective first deflecting mirror is arranged) is at least 20 mm. The tilt angle of the first deflecting mirror is, for example, at least 30° to the horizontal direction. In addition, it is advantageous for the accuracy of the inspection if the deflecting mirrors realise a very good optical imaging quality in order to avoid distortions in the image of the matrix camera.

The illuminated line-shaped area may extend over the entire length of the top side (including optionally the protruding first and second tabs). Here, the length of the top side is the dimension of the housing in the direction of its largest dimension. In this embodiment, the illuminated line-shaped area may be used to obtain image data with respect to the entire top side when the entire object is moved past the line lighting unit.

The matrix camera may be calibrated in such a way that perspective and/or optical distortion from the image data captured matrix-wise can be taken into account by the data processing unit. For such a calibration, the method described in the article ‘Digital camera self-calibration’, C. S. Fraser, ISPRS Journal of Photogrammetry & Remote Sensing 52 (1997), pages 149-159 is used, for example. In one embodiment of the device, the data processing unit is configured to determine at least one dimension of the object and/or at least one size of a detected defect after taking into account the perspective and the optical distortion. For this purpose, for example, a look-up table is determined in advance on the basis of the calibration, by means of which a conversion of a pixel number into a unit of length or area is provided. The look-up table is stored, for example, in a memory unit of the data processing unit.

In one embodiment, a position correction may additionally be carried out using the calibration and by using fixed points (e.g. the corner points of the housing) by means of the data processing unit. Here, the coordinates of the four corner points of the housing, for example, are determined by software-based ‘probing’ of the housing in a horizontal and vertical direction. Probing involves examining the respective rows and columns of the image data matrix for a change in intensity (large increase or decrease in intensity from one pixel to the next pixel). Position correction is advantageous for comparing the captured image data of the matrix with corresponding target values to determine defects or to determine a quality score, as the object may not always be in exactly the same position in the rest state. In one embodiment, the position correction may also be used to determine the location (position) of each detected defect in particular on the top side (optionally including the top tab surface). Based on this location information, a marking device downstream of the inspection device may, for example, mark the defect by applying (e.g. spraying on) a water-soluble colour by encircling it on the surface of the object. Alternatively or additionally, knowing the location of the defect may make it easier to control a device for removing the defect.

In one embodiment, by means of the data processing unit, the image data from at least one further camera, which is attached to the frame underneath the matrix camera, for example, may be included in the inspection method. In this way, it looks from above at the top side of the object, for example at the upper tab surface of a tab and, optionally, at an adjacent portion. The at least one further camera may, for example, generate images with a higher resolution in the specified sections of the object. The image data obtained from the corresponding fields of view is transmitted to the data processing unit and further information regarding smaller defects from these portions is generated from this.

The method for inspecting the object may be realised on the basis of the captured image data as a computer-implemented method, i.e. as a method carried out with the data processing unit (computer). The method may also include controlling the line illumination unit and/or the area illumination unit and/or the matrix camera such that a predetermined recording and/or illumination sequence is realised. For this purpose, the data processing unit and the line lighting unit and/or the area lighting unit are connected to each other by wire or wirelessly. The matrix camera is also connected to the data processing unit by a wired or wireless connection, also for transmitting the image data captured by the matrix camera to the data processing unit.

The data processing unit for processing the image data and determining whether a defect of at least one defect type exists and/or determining which quality score can be assigned to the object comprises a processor, which is a functional module that interprets and executes instructions/commands of algorithms and comprises a command control unit as well as an arithmetic unit and a logic unit. The processor may comprise at least a microprocessor, a digital signal processor (DSP), an application specific integrated circuit (ASIC), a field programmable gate array (FPGA-digital integrated circuit into which a logic circuit can be programmed), a discrete logic circuit or any combination of these components. The data processing unit may also comprise a memory unit, an input module (e.g. keyboard or touchpad), a power supply module (e.g. battery) and a display module (e.g. display). The data processing unit may be configured as a real hardware resource, for example a smartphone, desktop computer, server, notebook, cluster/warehouse scale computer, embedded system or the like, or as a virtualised computer resource. Furthermore, the data processing unit may comprise a transmitter/receiver (transceiver) for the exchange of data/image data with a display device (display). The data processing unit also comprises an interface for exchanging data with the line lighting unit and/or the area lighting unit and/or the matrix camera and/or a control device for the drive unit.

As has already been indicated above, the method explained above may, for example be realised as a computer program or computer-implemented method comprising instructions which, when executed, cause a processor of the data processing unit to perform the steps of the above method, wherein the computer program comprises a combination of the steps and data definitions described above which enable the computer hardware to perform computing or control functions, and/or is a syntactic unit which conforms to the rules of a particular programming language and which consists of declarations and statements or instructions required for the functions, tasks or problem solutions explained above.

Further disclosed is a computer program product comprising instructions which, when executed by the processor of the data processing unit, cause the device to perform the steps of any or all of the methods defined above. Accordingly, a computer readable medium storing such a computer program product is disclosed. The computer program product may be a software routine.

The above object is also solved by a device for inspecting three-dimensional objects, such as pouch cells, wherein each object comprises a substantially pouch-shaped or cuboid-shaped housing having a top side and a bottom side wherein the top side of the housing is composed of at least one upper surface section and a plurality of lateral surface sections which extend obliquely, parallel or perpendicular to the at least one upper surface section or represent corner sections, wherein the bottom side of the housing is composed of at least one lower surface section and a plurality of lateral surface sections which extend obliquely, parallel or perpendicular to the at least one lower surface section or represent corner sections, comprising a matrix camera which, for each object, generates matrix-wise captured image data of an area lighting unit's light reflected from the top side an in a rest state of the object to be inspected and transmits it to a data processing unit, wherein, the matrix-wise captured image data comprises light reflected from the lateral surface portions, wherein the data processing unit is configured to further process the matrix-wise captured image data as a first overall matrix and to perform the following steps:
segmenting the first overall matrix
   into a first image data portion comprising the image data of the upper surface section and
   into at least one second image data portion, wherein each second image data portion comprises the image data of at least one predetermined section of the lateral surface sections and/or at least one predetermined corner section,
subdividing the first image data portion into a plurality of individual patches,
identifying a defect type of a detected defect and/or a severity of a detected defect and/or determining a quality score that allows an assessment of the quality of the object based on
   determining separately for each patch of the plurality of patches whether the respective patch of the first image data portion comprises one or more anomalies by means of a correspondingly trained first NN algorithm, wherein a defect is identified if an anomaly is present, and
   identifying whether a defect is present in the at least one second image data portion and classifying the respective second image data portion accordingly by means of a correspondingly trained second NN algorithm which is different from the first NN algorithm.

In one embodiment of the above device, a camera, for example the matrix camera, is provided which is configured to generate a plurality of line-by-line captured image data of reflected light of a line lighting unit at line-shaped areas of the top side in a motion state of the object to be inspected and to transmit it to a data processing unit, wherein the data processing unit is configured to perform the following steps:
merging the line-by-line captured image data into a second overall matrix comprising the image data of the top side of the object,
identifying a defect type of a detected defect and/or a severity of a detected defect and/or determining a quality score which allows an assessment of the quality of the object, additionally based on the image data of the second overall matrix.

In another embodiment of the device, the data processing unit is configured to perform the following steps:
segmenting the second overall matrix
   into a third image data portion comprising the image data of the upper surface section and/or
   into at least one fourth image data portion, wherein each fourth image data portion comprises the image data of at least one predetermined section of the lateral surface sections and/or at least one predetermined corner section,
subdividing the third image data portion into a plurality of individual patches,
wherein identifying a defect type of a detected defect and/or a severity of a detected defect and/or determining a quality score that allows an assessment of the quality of the object based on
   determining separately for each patch of the plurality of patches whether the respective patch of the third image data portion comprises one or more anomalies by means of the first NN algorithm, wherein a defect is detected if an anomaly is present, and/or
   identifying whether a defect is present in the at least one fourth image data portion and classifying the respective fourth image data portion accordingly by means of the second NN algorithm.

In one embodiment of the device, the data processing unit is configured to determine at least one dimension of the object and/or at least one size of a detected defect after taking into account the perspective and/or the optical distortion of the matrix camera.

With regard to the above embodiments of the device, reference is made to the above explanations of the method and the device. Here, further embodiments and their advantages are presented, which are also to be regarded as disclosed for the corresponding device.

Further advantages, features and possible applications of the invention are described below with reference to embodiments and the figures. All features described and/or illustrated form the subject matter of the present invention, even independently of their summary in the claims and their references.

### BRIEF DESCRIPTION OF THE FIGURES

Schematically shows:

FIG. 1 is a first perspective view from the side of an embodiment of a device used for embodiments of the inventive method,

FIG. 2 is a second perspective view from another side of the device according to FIG. 1,

FIG. 3 is a side view of the device according to FIG. 1 with the peripheral rays of lighting devices and of the field of view of the matrix camera,

FIG. 4 is a front view of the device according to FIG. 1 with the peripheral rays of a lighting device and a centre ray of the field of view of the matrix camera,

FIG. 5 is a front view of the device according to FIG. 1 with the peripheral rays of lighting devices and the peripheral rays of the field of view of the matrix camera,

FIG. 6 is a lower section of the device according to FIG. 1 with the field of view of the matrix camera in a view from above,

FIG. 7 is a perspective view of an embodiment of a system consisting of two consecutively arranged devices according to FIG. 1,

FIG. 8 is a perspective side view of a first example of the design of an object (pouch cell),

FIG. 9 is a second perspective side view of a second example of the design of an object (pouch cell) and

FIG. 10 is a flow chart for an embodiment of an inventive method for inspecting.

### DETAILED DESCRIPTION OF PARTICULAR EMBODIMENTS

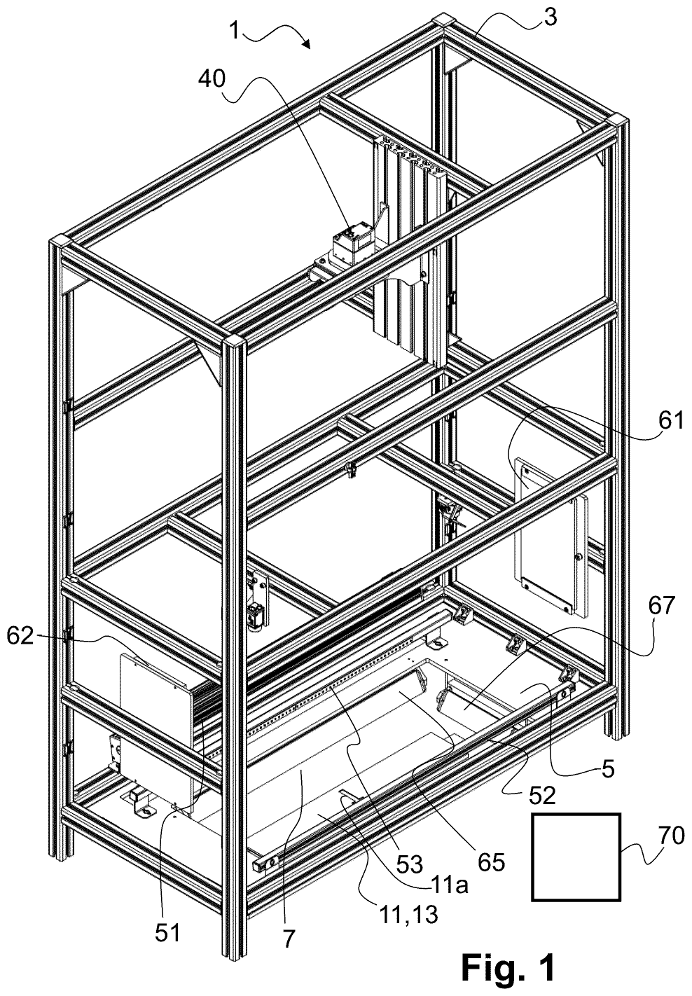

The device for inspecting shown in FIGS. 1 to 6 is used to inspect objects, e.g. in the form of pouch cells.

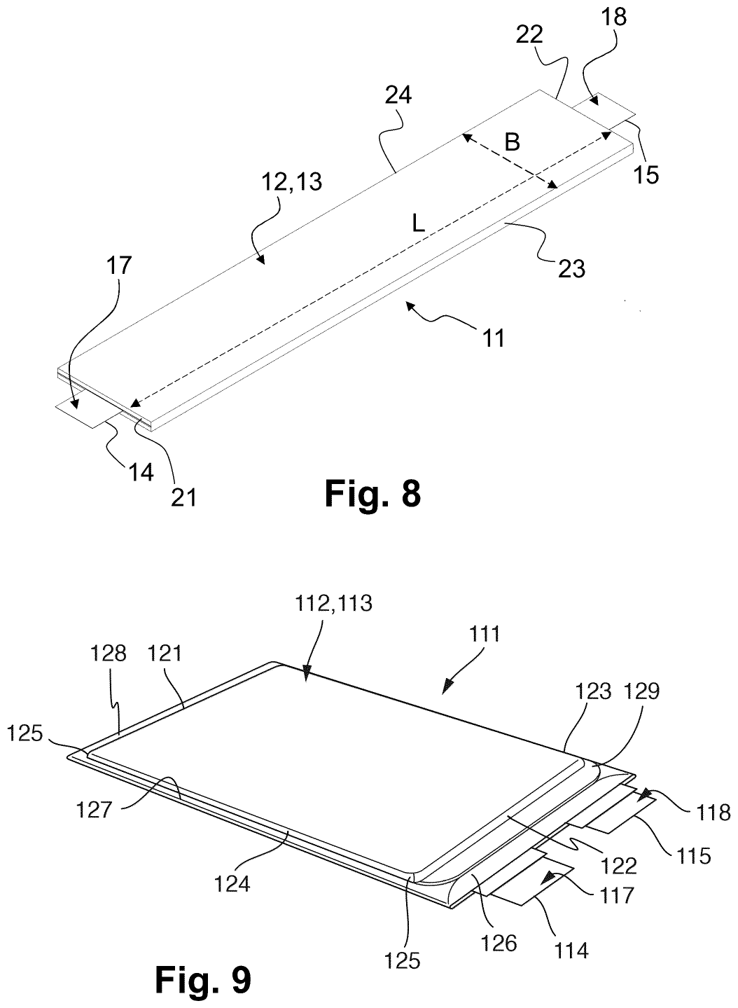

Two examples of pouch cells 11, 111 are shown in FIGS. 8 and 9.

The pouch cell 11 (see FIG. 8) comprises an essentially pouch-shaped housing 12. The housing 12 includes a first connecting tab (short: tab) 14 projecting from one short side and a second connecting tab (short: tab) 15 projecting from the opposite second short side. The pouch-shaped housing 12 comprises a top side with a substantially horizontally extending upper surface section 13. The first tab 14 has an upper tab surface 17 and the second tab 15 has a corresponding upper tab surface 18. Corresponding lower tab surfaces of the tabs 14, 15 are not visible in FIG. 8. The housing 12 is essentially cuboid in shape. The housing 12 comprises lateral surfaces 21, 22 on the short sides and lateral surfaces 23, 24 on the long sides. The lateral surfaces 21, 22, 23, 24 run approximately perpendicular to the horizontal upper surface section 13. The horizontal upper surface section 13, the upper tab surfaces 17, 18 of the tabs 14, 15 and the lateral surfaces 21, 22, 23, 24 together form the top side of the housing 12. The bottom side is correspondingly shaped and comprises a horizontal lower surface section, lower tab surfaces of the tabs 14, 15 and the lateral surfaces 21, 22, 23, 24. In this embodiment, the lateral surfaces 21, 22, 23, 24 belong to both the top side and the bottom side, as these can also be detected when inspecting the top side and the bottom side respectively. In FIG. 8, the length of the housing 12 is labelled L (not including tabs 14, 15) and the width is labelled B (see dashed double arrow lines). Due to the simple design of the pouch cell 11, it is used to explain the mode of operation of the inspection device 1 (see FIGS. 1 to 6). Accordingly, however, the inspection device 1 may also be used for other types of objects, in particular in the form of pouch cells.

FIG. 9 shows a second example of a pouch cell 111, which comprises a substantially pouch-shaped housing 112 with a horizontal upper surface section 113. The housing 112 also includes a first connecting tab 114 and a second connecting tab 115, which are adjacently arranged and project from a single short side. The first tab 114 has an upper tab surface 117 and the second tab 115 has an upper tab surface 118.

The pouch cell 111 further comprises side edges 121, 122, 123, 124 on the housing 112 around the horizontal upper surface section 113, which run at an angle to the horizontal upper surface section 113 and merge into it with a curve. Corners 125 are formed in the transition from one side edge to the neighbouring side edge 121, 122, 123, 124. Furthermore, the housing 112 comprises terrace sections 126, 127, 128, 129, each of which subsequently adjoin the side edges 121, 122, 123, 124 and run essentially parallel to the horizontal upper surface section 113. The top side of the housing 112 is formed by the horizontal upper surface section 113, the side edges 121, 122, 123, 124, the corners 125 and the terrace sections 126, 127, 128, 129.

The device 1 shown in FIGS. 1 to 6 for inspecting the pouch cell 11 has a support frame 3 on which a base plate 5 is arranged, which has a first through-going opening 7 and a second through-going opening 8 (see FIGS. 1, 2 and 6). Out of a plurality of pouch cells to be inspected, FIGS. 1 to 6 show two pouch cells 11, 31 to be inspected, which are guided past the inspection device 1 underneath the base plate 5, as illustrated by arrows 11a and 31a. The pouch cell 31 is another pouch cell with a structure as shown in FIG. 8.

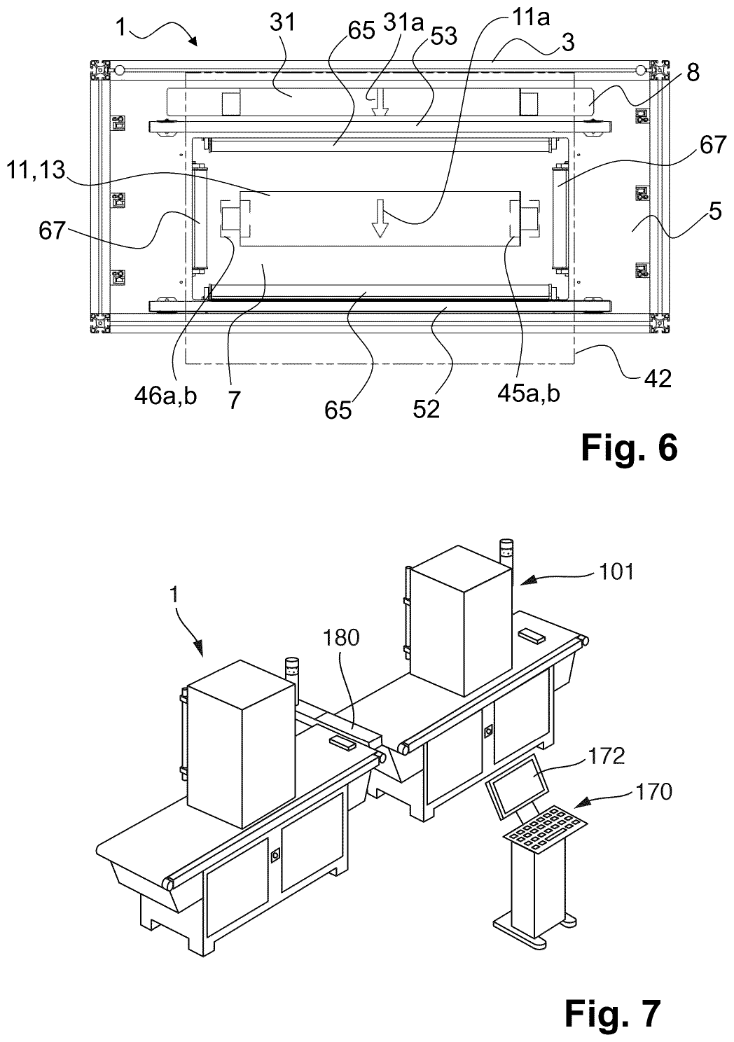

Above the base plate 5, a matrix camera 40 is arranged on the frame 3 viewing into the direction of the pouch cells 11, 31 from above through the openings 7, 8. Here, the pouch cells 11, 31 are arranged in such a way that the top side of the housing 12 is at the top in each case and the horizontal upper surface section 13 may be viewed from above with the matrix camera 40. The upper tab surface 17 of the first tab 14 and the upper tab surface 18 of the second tab 15 are also captured by the matrix camera 40. Here, the field of view 42 of the matrix camera 40 is so large (see in particular FIG. 6) that it extends over both openings 7, 8 in such a way that not only the pouch cells 11, 31 arranged under the respective opening 7, 8 are covered by the field of view 42 of the matrix camera 40 over their entire length and width (viewed from above), but also the deflecting mirrors 65, 67 arranged next to the pouch cell 11.

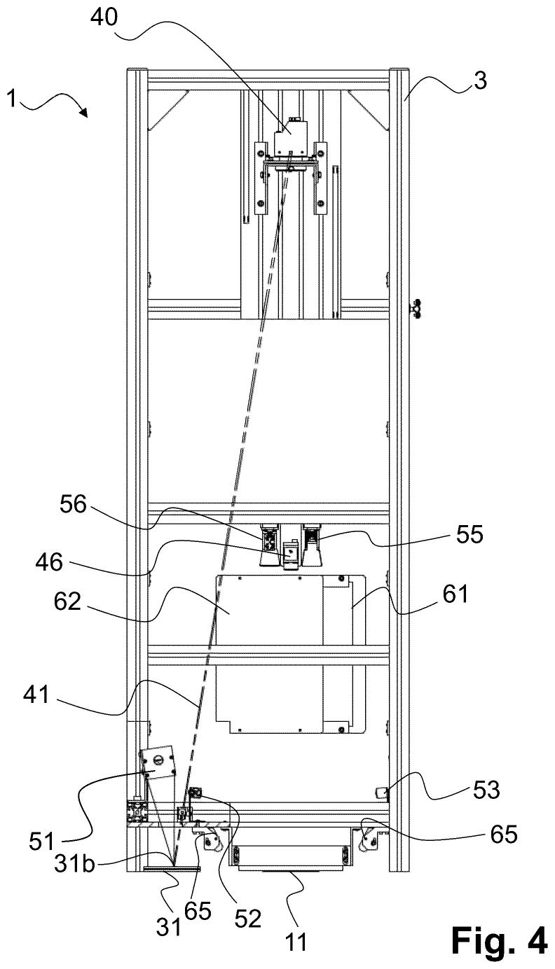

Furthermore, a line lighting unit 51 is provided on the frame 3, which illuminates a line-shaped area 31b of the top side of the housing and of the upper tab surfaces of the tabs. As can be seen from FIG. 4, the light reflected from the top side of the housing (including the upper tab surface) reaches the matrix camera 40 via the viewing ray 41 and is captured there. The matrix camera 40 thus captures the respective illuminated line-shaped area 31b of the pouch cell 31 line-by-line, wherein the pouch cell 31 moves transversely to the length of the opening 8 (see arrow 31 A in FIG. 6) during the capture, i.e. is in the motion state. A plurality of recordings is thus generated by means of the matrix camera 40. Each recording includes a respective capture of the respective illuminated line-shaped area of the top side of the housing (including the upper tab surfaces) of the pouch cell 31 moving past. The pouch cell is moved in the motion state by means of a drive unit described in more detail below and is caused to enter a rest state for a predetermined time period and is moved out of the inspection device from the rest state.

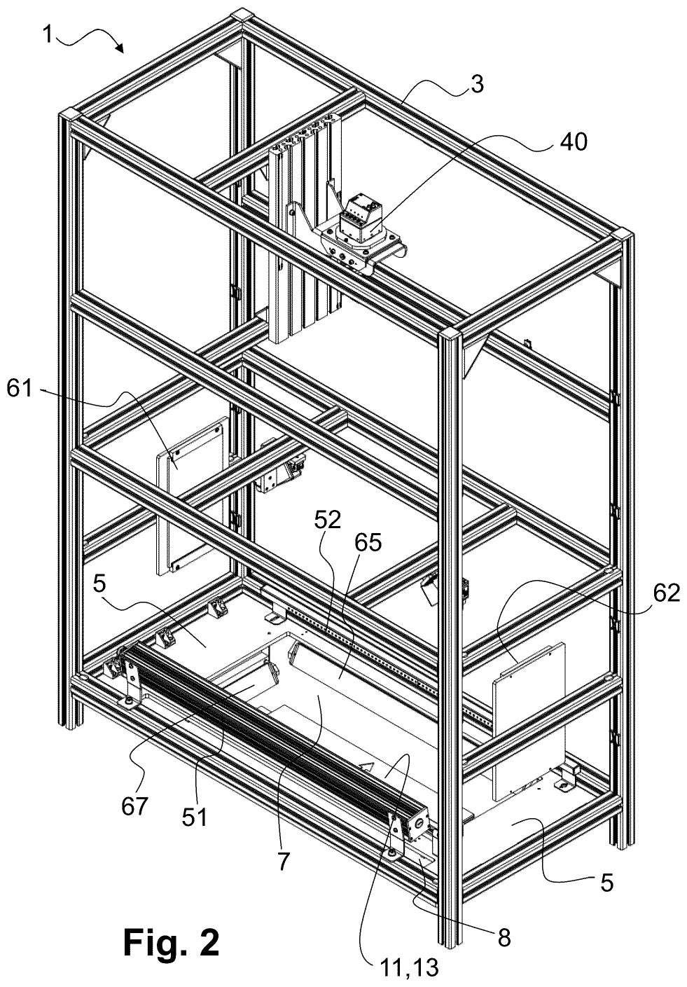

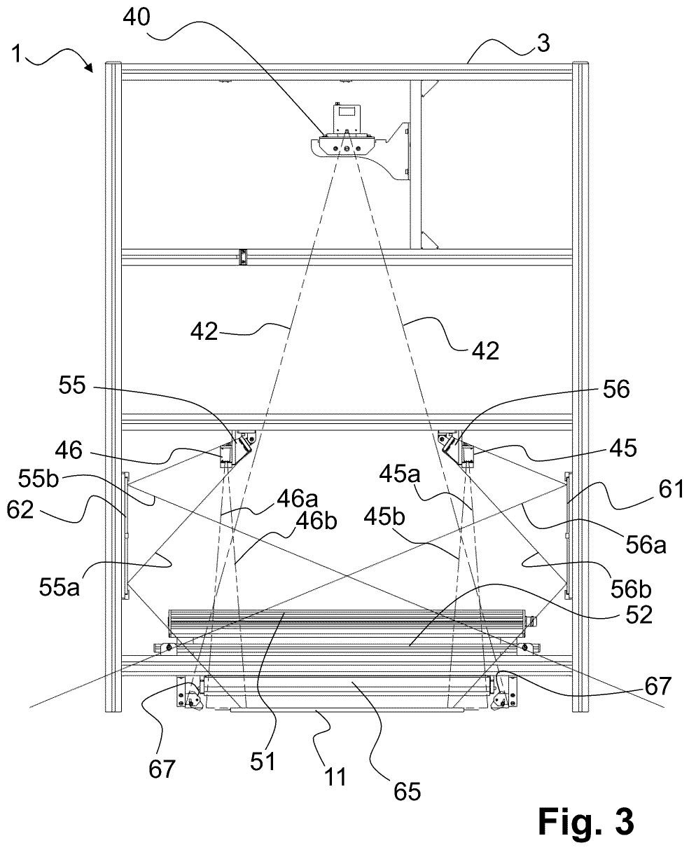

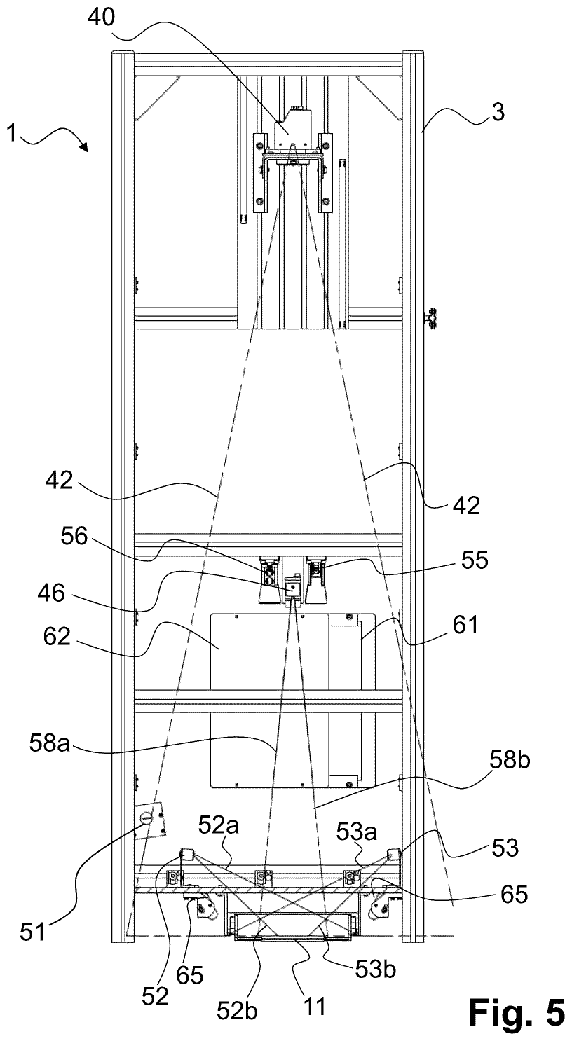

In addition, four area lighting units 52, 53, 55, 56 are provided on the frame. As can be seen from FIGS. 2, 3, 5 and 6 and the peripheral rays 52a and 52b or 53a, 53b of the area lighting units 52, 53 show, the area lighting units 52, 53 illuminate the top side of the housing 12 (including the upper tab surface 17, 18 of the tabs 14, 15) of the pouch cell 11 over the entire length L+tab length obliquely from above, so that in particular the side opposite the respective area lighting unit 52, 53 is captured in relation to the width of the pouch cell 11 (compare in particular FIG. 5), which is arranged below the opening 7 in the base plate 5. As can be seen from FIG. 3, the area lighting units 55, 56 illuminate the top side of the housing 12 (including the upper tab surface 17, 18 of the tabs 14, 15) via the mirrors 61, 62. Here, the light emitted by the area lighting unit 55 via the mirror 62 essentially illuminates the opposite first end of the pouch cell 11 and the light emitted by the area lighting unit 56 via the mirror 61 essentially illuminates the second end of the pouch cell 11 opposite the first end of the pouch cell (in the longitudinal direction). This can be understood by following the peripheral rays 55a, 55b, 56a and 56b. The area lighting units 52, 53, 55, 56 also partially illuminate the lateral surfaces 21, 22, 23, 24, so that reflections from these lateral surfaces and from the horizontally extending upper surface section 13 of the housing 12 are captured by the matrix camera 40. The light reflected from the lateral surfaces 21, 22, 23, 24 by the area lighting units 52, 53, 55, 56 is captured in particular via the deflecting mirrors 65, 67, which are provided next to the pouch cell 11 arranged below the opening 7 in such a way that the lateral surfaces 23, 24 on the long sides of the housing 12 of the pouch cell 11 are viewed by means of the deflecting mirrors 65, while the deflecting mirrors 67 serve to capture the lateral surfaces 21, 22 on the short sides of the housing 12 of the pouch cell 11.

The illumination by means of the area lighting units 52, 53, 55, 56 now takes place in such a way that these are each switched on one after the other so that the pouch cell 11 is illuminated obliquely from above by one area lighting unit, respectively, while the other three area lighting units are each switched off. For example, the illumination is first provided by the area lighting unit 52, then by the area lighting unit 55, then by the area lighting unit 53 and finally by the area lighting unit 56. The matrix camera 40 captures the reflected light in each of the four lighting states, wherein the pouch cell 11 is in the rest state in all four lighting states, i.e. in the same, predetermined position below the opening 7 in the base plate 5. Accordingly, four recordings of the entire top side of the housing 12 (including the upper tab surface 17, 18) are generated by means of the matrix camera 40, which capture these areas four times in a matrix, namely one time each when the area lighting unit 52, area lighting unit 55, area lighting unit 53 and area lighting unit 56 are switched on, wherein the pouch cell 11 is in the same position in each case.

In the four matrix-wise captures of the entire top side of the housing 12 (including the upper tab surface 17, 18), the lateral surfaces 21, 22, 23, 24 are also captured via the deflecting mirrors 65, 67, because the light reflected from these lateral surfaces 21, 22, 23, 24 reaches the matrix camera 40 via the deflecting mirrors 65, 67, because the field of view 42 of the matrix camera 40 includes these areas, as shown in FIG. 6.

The plurality of line-by-line captures and matrix-by-matrix captures of the pouch cells 11, 31 by the matrix camera 40 are transmitted to the data processing unit (computer) 70 (see FIG. 1) after they have been captured. The data processing unit 70 receives the image data from the line-by-line and matrix-by-matrix captures of the respective pouch cell 11, 31.

In this connection, the motion state and the rest state of the pouch cells 11, 31 are captured by means of a motion detection unit of the inspection device. For example, by monitoring the movement of a predetermined marking on the pouch cell 11, 31, for example a barcode, or corresponding signals from the drive unit, motion data is generated, which in particular contains information on the respective motion state in which the respective pouch cell 11, 31 is located. For example, the motion unit may transmit information to the motion detection unit that a pouch cell is ready for inspection (start signal). From this point in time, the motion detection unit may continuously capture the motion data of the motion unit and thus of the respective pouch cell (e.g. the speed of movement of the motion unit). Alternatively or additionally, the motion detection unit receives a signal when the line-by-line capture of the respective pouch cell is complete. Subsequently, a signal is generated by the motion unit or by means of a marking of the pouch cell and transmitted to the motion detection unit when the respective pouch cell is at the predetermined position of the rest state and remains there stationary. Once the matrix-wise capture of the respective pouch cell has been completed, the motion detection unit then generates another signal indicating that the respective pouch cell may be transported out of the inspection device. These signals also represent important motion data that is required for processing the image data.

These image data and the motion data are further processed and analysed by means of the data processing unit 70 and, as will be shown in more detail below, the object is assessed with regard to the presence of a defect of at least one defect type and/or a quality score is determined, which allows an assessment of the quality of the pouch cell 11, 31. In this context, the image data determined at different points in time from the line-by-line capture and the matrix-by-matrix capture are assigned to the respective pouch cell 11, 31 or to the motion state and to the rest state. This may, for example, be done using the motion data transmitted by the motion detection unit for the motion state and rest state of the respective pouch cell 11, 31. In this process, the image data of the recordings generated is corrected with regard to the image crop, the mirror distortion, the line-by-line capture (so-called line scan correction) and with regard to the position associated with the respective motion state or rest state.

The image data of the line-by-line capture of the respective pouch cell 11, 31 may be used, for example, to search for defects using bright field illumination (reflection bright field (RBF) illumination) or to determine a quality score, which relates in particular to an evaluation of the tab surfaces and a possible contamination by electrolytes.

For example, as explained in more detail below, a quality statement (quality score) is generated by the data processing unit 70 from the number, defect type and size/dimension of detected defects.

Further cameras 45, 46 are also arranged on the frame 3, which are attached to the frame 3 underneath the matrix camera. They observe the top side of the pouch cell 11 from above (see peripheral rays 45a, 45b, 46a, 46b) in such a way that they observe a top tab surface 17 of the first tab 14 and a top tab surface 18 of the second tab 15, as well as, if applicable, an adjacent portion of the upper surface section of the top side 13. The further cameras 45, 46 generate images with a higher resolution in the indicated portions of the pouch cell 11. The image data obtained from the corresponding fields of view are transmitted to the data processing unit 70 and further information with regard to the presence of smaller defects is generated therefrom.

FIG. 7 shows a system according to an embodiment of the invention for inspecting a pouch cell. The top side of the pouch cell (e.g. pouch cell 11) is first inspected by the inspection device 1. Subsequently, the pouch cell (e.g. pouch cell 11) reaches the turning unit 180 with a turning device and grippers with suction cups, which turns the pouch cell (e.g. pouch cell 11) so that the bottom side is now on top. Subsequently, the pouch cell (e.g. pouch cell 11), namely its bottom side (which is up there), is inspected by means of an inspection device 101, which is identical in construction to the inspection device 1. The processing of the image data obtained by means of the inspection devices 1, 101 with regard to the pouch cell (e.g. pouch cell 11) and the determination generated from this image data as to whether a defect/several defects of at least one defect type are present and/or determination of a quality score which allows an assessment of the quality of the object is carried out by means of the data processing unit 170, which is connected to a display 172 for displaying the results of the inspection. The pouch cell (e.g. pouch cell 11) is transported from the first inspection device 1 to the turning device 180 and to the second inspection device 101 by means of a drive unit comprising, for example, slides which are displaceable on a linear unit. The respective pouch cell is attached to a slide by means of suction cups. After completion of the capture of the image data by the matrix camera 40 and optionally by the further cameras 45, 46, in particular after completion of the matrix-wise capture of the respective pouch cell, a corresponding signal is generated by the inspection device, which is transmitted to the control of the drive unit. The drive unit is then controlled in such a way that it moves the respective pouch cell out of the respective inspection device 1, 101 and, if necessary, moves it to the turning device 180 in order to be subsequently turned and then transported to the second inspection device 101.

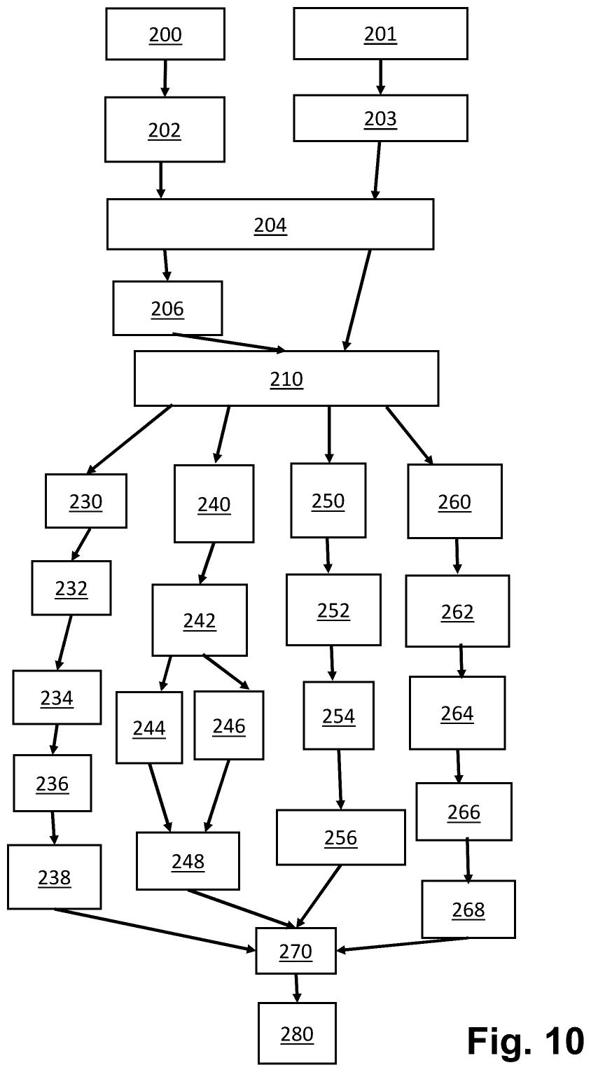

The analysis of the captured image data to determine the presence of a defect and/or to determine a quality score may be performed, for example, as follows. The procedure is illustrated using the flow chart shown in FIG. 10.

The starting point for the analysis of the captured image data is the four matrix-wise captured image data 200 of the top side of the object generated by illumination from different illumination directions and the line-wise captured image data 201 of the top side of the object using the pouch cell 101 as an example.

As described above, the perspective and/or the optical distortion of the matrix camera is first compensated in a step 202 for each of the four image data captured matrix-wise. Subsequently, the current position of the object during optical capture by the matrix camera is corrected in a step 204 (position correction), if necessary, i.e. rotated and/or shifted so that the image data takes up a predetermined position of the object in the field of view of the matrix camera. At the same time, the plurality of single line-by-line captured image data 201 is merged by the data processing unit 70 in step 203 into a single image (data), wherein this single image contains a matrix of image data, and corrected for inconsistencies during merging of the image of the top side of the object from the line-by-line captured image data, as described above. Subsequently, this data is also corrected in step 204 with respect to its position as described above. The merged and corrected line-by-line captured image data forms the second overall matrix.

For the four matrix-wise captured, compensated and corrected image data, the determination of a maximum image, an absorption image and/or a topology image subsequently follows in step 206 of the top side of the object. The calculation from the four matrices of image data is described in detail above. The maximum image is also referred to as the first overall matrix.

Segmentation is now carried out in step 210. As explained above in detail, layout recipes may be used to extract desired image data portions from the respective (corrected) image data matrix of the top side determined by matrix-wise capture or line-by-line capture. For example, a first image data portion is extracted in the form of the upper surface section (image data from direct recording by the camera/matrix camera) 113, a second image data portion is extracted from the recording areas via the mirrors on the shorter side in the form of the two corner sections 125 and a further second image data portion is extracted in the form of the four terrace sections (image data from direct recording by the camera/matrix camera) 126, 127, 128, 129. The segmentation is performed with respect to the corrected and merged line-by-line captured image data (i.e. from the second overall matrix) as well as with respect to the matrix-by-matrix captured, compensated and corrected image data and the maximum image (first overall matrix) and/or the absorption image and/or the topology image. Subsequently, the image data portions obtained by segmentation are processed in parallel and finally fed to an overall evaluation of the object.

In step 230, the result of the segmentation is, for example, an image data portion of the upper surface in the maximum image, in the absorption image, in the topology image and in the second overall matrix, respectively. In step 232, the data processing unit 70 examines each of these image data portions with respect to each pixel to determine whether they exceed a predetermined threshold value. Such a threshold value may be 240 for the image data portion of the maximum image, 220 for the image data portion of the topology image, 203 for the image data portion of the absorption image and 120 for the image data portion of the second overall matrix. If the image data value of the respective pixel is at or above the respective threshold value, a defect is detected. Subsequently, in step 234, further properties of the detected defect are determined, for example its size (by analysing whether a defect was also detected in neighbouring pixels) in pixels, a histogram of the image data values in the area of the respective defect, and/or the shape and orientation of the defect. The defect type is then determined in step 236 using the properties of the defect found and any other defects found in the image data portion, wherein different images/matrices in relation to the same location of the image data portion may be considered for this purpose. For example, based on the absence of a defect at the location in the absorption image, based on the determined ratio of length to width in the absorption image being greater than 5 and based on an average value of an image data histogram along the defect in the topology image that is greater than 200, all together the defect type ‘scratch’ may be concluded. In step 238, the severity of the detected scratch defect is then determined, wherein the determination may, for example, be based on an assignment of the size of the scratch to severity classes. In this context, if the defect is smaller than 2 pixels, the scratch defect can be assigned a severity level of zero, if the defect is greater than or equal to 2 pixels and smaller than 4 pixels, the scratch defect can be assigned a severity level of 1, if the defect is greater than or equal to 4 pixels and smaller than 6 pixels, the scratch defect can be assigned a severity level of 2, and so on.

The result of the segmentation in step 240 are, for example, image data portions in the form of four “corner sections” (e.g. 128×128 pixels) from the maximum image determined in step 206, wherein the “corner sections” are obtained, for example, from the image data generated via the mirrors 67 on the short side of the pouch. As explained above, a CNN algorithm with a binary classifier is now applied to these image data portions in step 242. As a result, the attribute ‘defective corner’ (step 244) or ‘intact corner’ (step 246) is determined for each corner image data portion and assigned to the respective corner in step 248.

Results of the segmentation in step 250 are, for example, image data portions in the form of terrace portions (to the terraces 126, 127, 128, 129) from the maximum image determined in step 206, wherein the image data has been generated by direct capture by means of the matrix camera 40 from above. Now, the mask RCNN algorithm is applied to these terrace image data portions (described in more detail above, step 252). As a result, defects in the terrace image data portions of different defect types are recognised and provided with a bounding box (step 254). The severity of the respective defect is subsequently also determined in relation to the defects detected at the terrace image data portions, for example based on the detected defect type, the size of the bounding box, the shape of the bounding box, etc. (step 256).

The result of the segmentation is, for example, in step 260, image data portions in the form of the upper surface section 113, for example the maximum image, and in the form of the second overall matrix (from the line-by-line capture). These image data portions are divided into patches in step 262, wherein, if applicable, previously the resolution of the respective portion is reduced to the pre-defined value (for example see above). Subsequently, in step 264, as described above, the image data portions may be analysed using the pre-trained CNN algorithm ‘Wide ResNet-50’ and, if applicable, an anomaly or anomalies may be detected in some patches. In step 266, the Mahalanobis distance to the normal distribution is determined for each patch in which an anomaly was detected and each detected anomaly are determined. From this, the severity of the anomaly and thus of the respective defect is determined in step 268.

In all of the above cases, the severity of the defect is expressed in terms of predetermined classes.

Subsequently, in step 270, the data processing unit 70 evaluates the quality of the pouch cell 111 as a whole based on all the defects determined in the four analysis strands, the respective defect type and the respective severity of the defect. It is being assessed whether the pouch cell 111 as a whole fulfils the specified quality requirements or not. In step 280, the result of the overall assessment is provided at an interface of the data processing unit, optionally together with a list of the determined defects and their characteristics. For example, a pouch cell with two defects of type ‘Dent’ of severity class 5 is judged to be sufficient for the quality requirements. In contrast, a pouch cell having a defect of the defect type ‘Dent’ of severity class 7, for example, may be classified as not meeting the quality requirements.

The above method may also be carried out analogously for the bottom side of the pouch cell.

As indicated above, the method according to embodiments of the invention may be used to carry out an inspection of a three-dimensional object, e.g. a pouch cell, in a simple and fast manner, wherein the various properties of the sections of the object may be taken into account during the analysis.

1. A method of inspecting three-dimensional objects, wherein each object has a top side and a bottom side, wherein the top side is composed of at least one upper surface section and a plurality of lateral surface sections which run obliquely, parallel or perpendicular to the at least one upper surface section or form corner sections, wherein image data captured matrix-wise by a matrix camera is generated for each object from an area lighting unit's light reflected from the top side in a rest state of the object to be inspected and transmitted to a data processing unit, wherein the image data captured matrix-wise comprises light reflected from the lateral surface sections, wherein the image data captured matrix-wise is further processed as a first overall matrix by the data processing unit,
wherein the method comprises the following steps performed by the data processing unit:
segmenting the first overall matrix
into a first image data portion comprising the image data of the upper surface section and
into at least one second image data portion, wherein each second image data portion comprises the image data of at least one predetermined portion of the lateral surface sections and/or at least one predetermined corner section,
subdividing the first image data portion into a plurality of individual patches,
identifying a defect type of a detected defect and/or a severity of a detected defect and/or determining a quality score allowing an assessment of the quality of the object, based on
a specific determination for each patch of the plurality of patches whether the respective patch of the first image data portion comprises one or more anomalies, by a correspondingly trained first neural network (NN) algorithm, wherein a defect is identified if an anomaly is present, and
an identification of whether a defect is present in the at least one second image data portion, and a corresponding classification of the respective second image data portion by means of a correspondingly trained second NN algorithm which is different from the first NN algorithm.

2. The method according to claim 1, wherein the classification of the at least one second image data portion is carried out by a classifier with two states or a classifier with at least 3 states, wherein the classifier with at least 3 states allows the assignment of different types of defects.

3. The method according to claim 1, wherein, for each object, generating, by a camera, a plurality of line-by-line captured image data of reflected light of a line lighting unit at line-shaped areas of the top side in a motion state of the object to be inspected and transmitting the generated image data to a data processing unit, wherein the method further comprises the following steps performed by the data processing unit:
merging the image data captured line-by-line into a second overall matrix comprising the image data of the top side of the object, and
identifying a defect type of a detected defect and/or a severity of a detected defect and/or determining a quality score which allows an assessment of the quality of the object, additionally based on the image data of the second overall matrix.

4. The method according to claim 3, the method further comprises the following steps performed by the data processing unit:
segmentation of the second overall matrix
into a third image data portion comprising the image data of the upper surface section and/or
into at least one fourth image data portion, wherein each fourth image data portion comprises the image data of at least one predetermined section of the lateral surface sections and/or at least one predetermined corner section,
subdividing the third image data portion into a plurality of individual patches, and
identifying a defect type of a detected defect and/or a severity of a detected defect and/or determining a quality score that allows an assessment of the quality of the object based on
determining specifically for each patch of the plurality of patches whether the respective patch of the third image data portion comprises one or more anomalies by the first NN algorithm, wherein a defect is identified if an anomaly is present, and/or
identifying whether a defect is present in the at least one fourth image data portion and classifying the respective fourth image data portion accordingly by the second NN algorithm.

5. The method according to claim 1, wherein for each object at least n (n≥2) recordings of the top side of matrix-wise captured image data are generated by a temporally successive capture of reflected light and transmitted to the data processing unit, wherein the matrix-wise captured image data are further processed as n first overall matrices by the data processing unit, and wherein the reflected light is generated by a temporally separated illumination of the top side of the housing of the object in the rest state of the object to be inspected obliquely from above from n different directions.

6. The method according to claim 5, further comprising the following steps performed by the data processing unit:
segmentation of the n first overall matrices
into n fifth image data portions comprising the image data of the upper surface section of each of the n first overall matrices and/or
into n sixth and optionally further image data portions of each of the n first overall matrices, wherein each sixth and optionally further image data portion comprises the image data of at least one predetermined portion of the lateral surface sections and/or at least one predetermined corner section,
determining in each case a maximum image and/or an absorption image and/or a topology image from the image data of the fifth image data portion and/or the sixth image data portion and/or the possibly further image data portions,
determining defects as well as analysing and characterising defects in the maximum image and/or in the absorption image and/or in the topology image of the fifth image data portion and/or of the sixth image data portion and/or of the further image data portions, if applicable,
wherein the identification of a defect type of a detected defect and/or a severity of a detected defect and/or the determination of a quality score, which allows an assessment of the quality of the object, is based on the result of the analysis and/or characterisation of the respective detected defects.

7. The method according to claim 1, further comprising using a patch distribution modelling framework for anomaly detection to detect an anomaly in a patch, wherein the degree of anomaly is determined by Mahalanobis distance with respect to a normal distribution expected in the respective patch.

8. The method according to claim 1, wherein a location of the anomaly in the respective patch is determined and used to locate a possible defect in/on the object.

9. The method according to claim 1, wherein at least one dimension of the object and/or at least one size of a detected defect is determined by the data processing unit after taking into account the perspective and/or the optical distortion of the matrix camera.

10. The method according to claim 1, further comprising carrying out a position correction by the data processing unit by predetermined reference points of the object.

11. The method according to claim 1, wherein the resolution of the first image data portion and/or the third image data portion is reduced before the first image data portion and/or the third image data portion is subdivided into a plurality of individual patches.

12. A device for inspecting three-dimensional objects, wherein each object has a top side and a bottom side, wherein the top side of the housing is composed of at least one upper surface section and a plurality of lateral surface sections which extend obliquely, parallel or perpendicular to the at least one upper surface section or represent corner sections, the device comprising:
a matrix camera which, for each object, generates matrix-wise captured image data of an area lighting unit's light reflected from the top side in a rest state of the object to be inspected and transmits it to a data processing unit, wherein, the matrix-wise captured image data comprises light reflected from the lateral surface portions,
the data processing unit which is configured to further process the matrix-wise captured image data as a first overall matrix and to perform the following steps:
segmenting the first overall matrix
into a first image data portion comprising the image data of the upper surface section and
into at least one second image data portion, wherein each second image data portion comprises the image data of at least one predetermined section of the lateral surface sections and/or at least one predetermined corner section,
subdividing the first image data portion into a plurality of individual patches,
identifying a defect type of a detected defect and/or a severity of a detected defect and/or determining a quality score that allows an assessment of the quality of the object based on
determining separately for each patch of the plurality of patches whether the respective patch of the first image data portion comprises one or more anomalies by a correspondingly trained first NN algorithm, wherein a defect is identified if an anomaly is present, and
identifying whether a defect is present in the at least one second image data portion and classifying the respective second image data portion accordingly by a correspondingly trained second NN algorithm which is different from the first NN algorithm.

13. The device according to claim 12, wherein a second camera or the matrix camera is configured to generate a plurality of line-by-line captured image data of reflected light of a line lighting unit at line-shaped areas of the top side in a motion state of the object to be inspected and to transmit it to the data processing unit or a second data processing unit,
wherein either of the data processing unit is configured to perform the following steps:
merging the line-by-line captured image data into a second overall matrix comprising the image data of the top side of the object, and
identifying a defect type of a detected defect and/or a severity of a detected defect and/or determining a quality score which allows an assessment of the quality of the object, additionally based on the image data of the second overall matrix.

14. The device according to claim 13, wherein either of the data processing unit is configured to perform the further following steps:
segmenting the second overall matrix
into a third image data portion comprising the image data of the upper surface section and/or
into at least one fourth image data portion, wherein each fourth image data portion comprises the image data of at least one predetermined section of the lateral surface sections and/or at least one predetermined corner section,
subdividing the third image data portion into a plurality of individual patches,
wherein identifying a defect type of a detected defect and/or a severity of a detected defect and/or determining a quality score that allows an assessment of the quality of the object based on
determining separately for each patch of the plurality of patches whether the respective patch of the third image data portion comprises one or more anomalies by the first NN algorithm, wherein a defect is detected if an anomaly is present, and/or
identifying whether a defect is present in the at least one fourth image data portion and classifying the respective fourth image data portion accordingly by the second NN algorithm.

15. The device according to claim 12, wherein the data processing unit is configured to determine at least one dimension of the object and/or at least one size of a detected defect after taking into account the perspective and/or the optical distortion of the matrix camera.
